(19) United States
(12) Patent Application Publication
(10) Pub. No.: US 2010/0050104 A1
(43) Pub. Date: Feb. 25, 2010

(54) System and Method for Automatic Instrument Address Recognition

(76) Inventor: Franco Stellari, Waldwick, NJ (US)

Correspondence Address: F. CHAU & ASSOCIATES, LLC, 130 WOODBURY ROAD, WOODBURY, NY, 11797, US

(21) Appl. No.: 12/195,252

(22) Filed: Aug. 20, 2008

(51) Int. Cl. G06F 13/20; G06F 3/048

(52) U.S. Cl. 715/771; 710/3

(57) ABSTRACT

A method for automatic instrument address recognition includes requesting a list of instruments attached to a bus, collecting the list of instruments, querying each listed instrument for an identification string, comparing the identification string of each instrument to a matching pattern, and determining a match of the identification string with an instrument of interest, and selecting an address of the instrument having the identification string matching the matching pattern and returning the address for controlling the instrument of interest.

### BACKGROUND

1. Technical Field

The present invention relates generally to the field of network management and more specifically to automatic instrument address recognition.

2. Discussion of Related Art

Running complex experiments in the lab requires the concurrent use of many different instruments, such as power supplies, voltage and current meters, pulse generators, oscilloscopes, analog and digital signal sampling, etc. For example, the power on procedure of the IBM 65 nm Z6 processor requires initializing and turning on, in sequence, eight different power supplies, as well as providing two differential clock signals through an external pulse/pattern generator.

Software programming through dedicated packages, such as National Instrument LabView and LabWindows, has become a standard approach to instrument control and experiment automation. The instruments are typically connected together through a bus, such as the IEEE 488.2 also called General Purpose Interface Bus (GPIB), connected to a central control unit, a computer, running the control software and a Graphical User Interface (GUI) that allows for the user interaction. Additional methods of connecting the instrument to the controlling computer include serial cables, USB ports, Ethernet Local Area Network (LAN), etc.

Referring to FIG. 2, each instrument on the bus has a unique address that can be configured from the instrument panel (see block 201). At block 202, the control program/software needs to know the address of each instruments to be controlled to send the appropriate commands to the appropriate instrument. At block 203, sending commands to the wrong instrument may cause unexpected behavior and possible damage to the experiment connected the instrument: e.g., by destroying a chip by applying an excessive voltage to the wrong power supply.

Determining these addresses includes, manually checking the address at each instrument and comparing the address to the one used in the code. As a consequence, setting up, updating, and verifying that the control software is using the correct address for each instrument is cumbersome and prone to errors. Moreover, the instrument front panel may be difficult to access from the location of the computer due to distance, space, or environment.

Therefore, a need exists for a method of automatic address recognition.

### BRIEF SUMMARY

According to an embodiment of the present disclosure, a method for automatic instrument address recognition includes requesting a list of instruments attached to a bus, collecting the list of instruments, querying each listed instrument for an identification string, comparing the identification string of each instrument to a matching pattern, and determining a match of the identification string with an instrument of interest, and selecting an address of the instrument having the identification string matching the matching pattern and returning the address for controlling the instrument of interest.

According to an embodiment of the present disclosure, a network management system includes a data communications bus, a plurality of instruments connected to the data communications bus, and a computer system connected to the data communications bus for controlling at least one of the instruments, the computer system comprising a processor and a memory storing instructions executable by the processor to perform a method for automatic instrument address recognition.

According to an embodiment of the present disclosure, a method for automatic instrument address recognition includes requesting a list of instruments attached to a bus, collecting the list of instruments, querying each listed instrument for a respective identification string, comparing the respective identification string of each instrument to a matching pattern, and determining a match corresponding to at least one instrument of interest, selecting an address of the at least one instrument of interest having the respective identification string matching the matching pattern and returning selected addressed for controlling the at least one instrument of interest, and sending a command to a respective address of the at least one instrument of interest for performing a task.

According to an embodiment of the present disclosure, a method of creating a networked device includes providing a network, wherein the network comprises an instrument, a bus, and a controller, requesting, by the controller, a list of instruments attached to a bus including the instrument, collecting the list of instruments, querying each listed instrument for an identification string, comparing the identification string of the instrument to a matching pattern, and determining a match of the identification string with the instrument, selecting an address of the instrument having the identification string matching the matching pattern and returning the address for controlling the instrument of interest, and opening a connection between the controller and the instrument via the bus to create the networked device comprising the instrument, the bus, and the controller, wherein the instrument receives a query from the controller via the bus and performs a process in response to the query.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a flow diagram of a method for discovering device addresses according to an embodiment of the present disclosure;

FIG. 2 is a flow diagram of a method for sending a command to an instrument;

FIG. 3 is a flow diagram of a method for sending a command to an instrument according to an embodiment of the present disclosure;

FIGS. 4 and 5 are GUIs for user interaction for automatic instrument address recognition according to an embodiment of the present disclosure;

FIGS. 6 and 7 are flow diagrams methods for automatic instrument address recognition according to an embodiment of the present disclosure; and

FIG. 8 is a diagram of a system for automatic instrument address recognition according to an embodiment of the present disclosure.

### DETAILED DESCRIPTION

According to an embodiment of the present disclosure, a method for the automatic recognition of an instrument from a controller side includes querying an identification of the instrument through a bus and matching the identification with an identification pattern.

According to an embodiment of the present disclosure, instrument addresses are automatically setup inside instrument control software. For example, assume that one wants to control a particular instrument, e.g., the air flow of a Temptronik cooling unit, and the instrument address is not certain. The software searches for the instrument on a bus until a unique ID identifying the instrument of interest is located, e.g. “TP0300” that identifies the Temptronik cooling unit used in the lab. A list of instruments connected to the bus may be retrieved and the list of the instruments and addresses may be used to determine additional information about the instrument, match the instrument with user provided information and automatically select the address of the matching instrument.

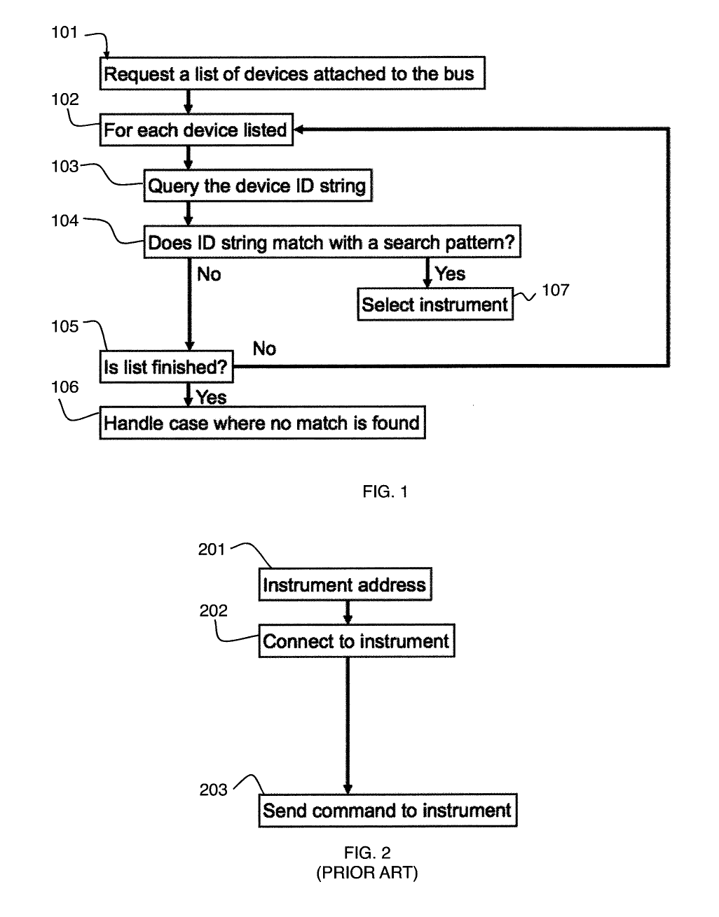

Referring to FIG. 1, a list of instruments attached to the bus is requested at block 101. This may be achieved in several ways, e.g., using low level commands specific to the various interfaces to be used. At block 102, the list of instruments may be collected completely before proceeding to a following step or the instrument addresses may be returned one at the time in a loop, where all subsequent steps are done for each instrument before proceeding to retrieve the address of a subsequent instrument on the bus. At block 103, each instrument listed is queried for its identification string (such as that defined by a device manufacturer). This can be implemented with low level functions that allow for a query command to the instrument to gain additional information regarding the instrument, such as, maker, model type and number, revision, etc. At block 104, the identification string of each instrument is compared to a matching pattern in the controller software. The user provides the program/software with certain search criteria such as a specific instrument type and model and requests the software to retrieve the address of such specific instrument. A match of the identification string with the instrument of interest is determined at block 104; such decision may be implemented with matching algorithms such as regular expressions, and be case sensitive, and employ one or more matching parameters: such as model number and revision number. At block 107, based on the previous decision, the address of the matching instrument is selected if a matching instrument is found, and its address is returned to the control program for being used in normal operations involving the control of such instrument. Cases where more than one instrument is found or none at all must be handle appropriately (more details below). If the list of instruments is not created before the loop, but each instrument is retrieved one at the time, the software may also decide to stop the searching loop upon identifying the first match. At block 105 a determination is made about whether all instruments have been queried. At block 106, the case when there are no instruments connected to the bus that match the user criteria is handled.

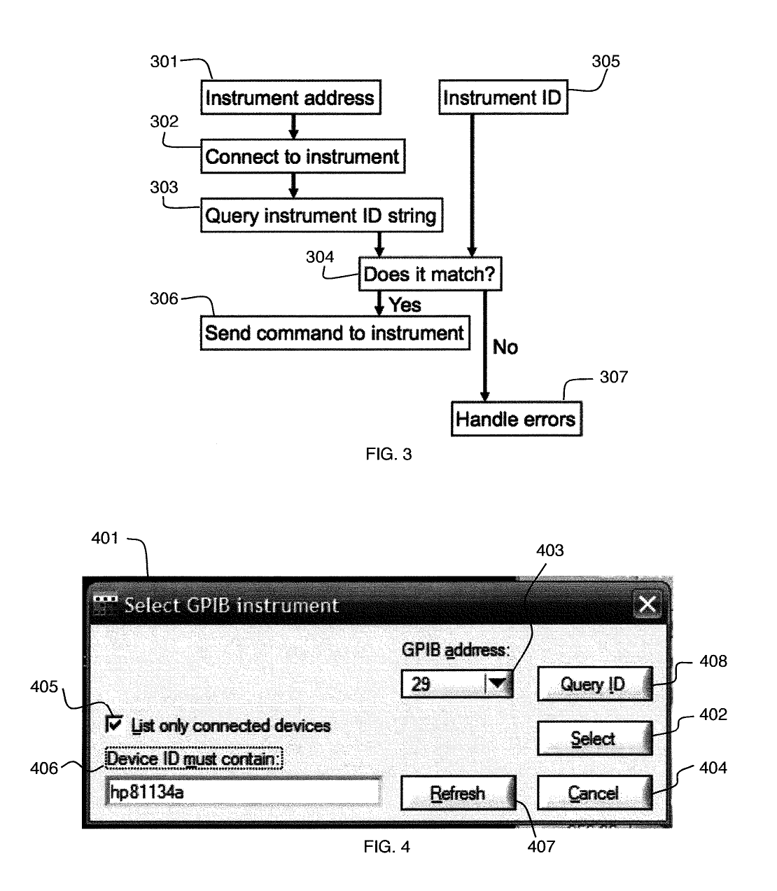

According to an embodiment of the present disclosure, an instrument with a certain bus address can be verified. For example, assume that a certain clock frequency is to be setup on an Agilent HP81134A pulse/pattern generator that was formerly at address X; before issuing a command, or before any operation, the software can verify that the ID of the instrument matches the expected pattern. Referring to FIG. 3, each instrument on the bus has a unique address that can be configured from the instrument panel (see block 301). At block 302, the software opens a connection to the instrument. Note that querying the instrument ID is usually implemented in standard ways common to instruments and does not affect the instrument state, behavior and outputs. At block 303, the instrument at address X is queried for its identification string; for example, “*IDN?” is a query string that can be used for SCPI (Standard Commands for Programmable Instrumentation) compliant instruments. In this exemplary query the “?” modifies the command and makes it a request to the instrument “IDN”: for example “VOLT 1” may set the voltage to 1 for a certain instrument but “VOLT?” may request what voltage to set to the same instrument. Further, in this example, the “*” defines a special class of commands that are typically instrument independent, such as reset (*RST), requesting ID (*IDN?), etc. Further discussions of how to query an instrument ID are given below and can vary depending on the protocol. At block 304, the identification string of the instrument is compared to a matching pattern in the controller software (see block 305). The pattern may be provided by the user, implemented in the software or saved from a previous “gold” access to the instrument, etc. At block 304, the method determines if the identification string has a positive match with the instrument of interest. Based on the decision at block 304, allow for the command to be issued at block 306 or take corrective actions (i.e., warn the user of a problem) at block 307.

The code examples herein are based on C/C++ programming relying on the National Instrument VISA (Virtual Instrument Software Architecture) library for controlling instruments on GPIB busses. The same apply for other interfaces, languages, hardware vendors, etc.

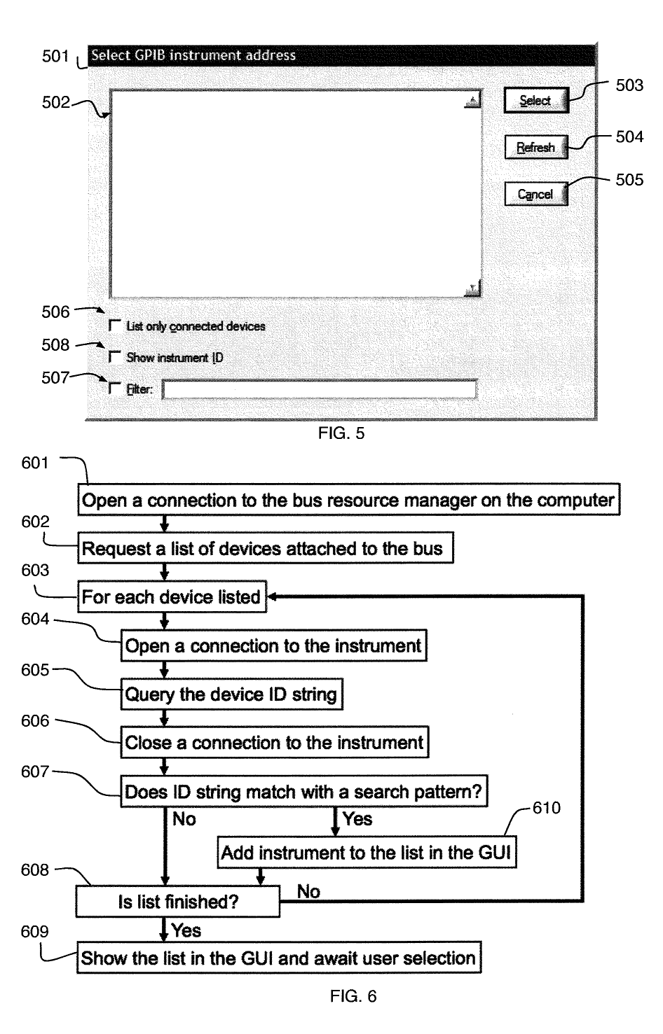

According to an embodiment of the present disclosure, the user may be aided in the selection of the bus address of a specific instrument through a GUI (FIG. 4 and FIG. 5). These exemplary GUIs are designed to guide the user through the processes described for the selection of instruments based on matching criteria.

Referring to FIG. 4 a panel/dialog box 401 is presented with several buttons, check boxes, text entry and a result list/combo box. “Select” button 402 exits the dialog box returning the instrument address currently highlighted/selected in the “GPIB address” combo/list box 403. The “Cancel” button 404 exits the panel without making any selection. If the “List only connected devices” box 405 is not selected, then both the text entry box “Device ID match” 406 and the “Refresh” button 407 are disabled. In this mode the “GPIB address” 403 list is filled with all possible addresses allowed by the interface, without any discrimination if they are connected or what type they are. Additional functionality is implemented by the “Query ID” button 408 that allows the user to query the currently selected instruments for its ID. A popup dialog box shows such ID string in case the instrument is connected or an error message in case the address is not associated with a real instrument on the bus. When the “List only connected devices” box 405 is checked, the software retrieves a list of instruments on the bus and fills up the “GPIB address” combo/list box 403 with the addresses of instruments currently connected, thus removing invalid addresses. Additionally, the “Device ID match” edit box 406 is now enabled and entering a match pattern causes the software to query each of the connected instruments for their ID that is subsequently matched to the entered text and only the connected instruments matching the search string are listed in the combo/list box. The match pattern may be an entire ID or a portion of an ID. The update of the list may take place automatically when changes are made in the “List only connected devices” box 405 and/or “Device ID match” 406 or manually suing the “Refresh” button 407. The “Refresh” button 407 may be used if the configuration of instruments connected to the bus is changed while no change in the search criteria are made in the dialog. The “Query ID” 408 can also be sued to retrieve the full ID of the instruments to aid the user selection. The list may contain 0, 1, >1 instrument address. In the first case (0) the “Select” button 402 cannot be used since there is no selection to make. In the latter case (>1) the user may refine the search criteria or use the “Query ID” button 408 to further help the selection of the correct address.

The GUI 501 of FIG. 5 may be an alternative to FIG. 4 and includes a dedicated instrument list 502 that allows displaying additional information such as the instrument ID string along with the address. A “Select” button 503 closes the panel and returns the currently selected instrument in the list (enabled only if there is a valid selection); “Refresh” 504 updates the list content based on the settings at the bottom of the window; “Cancel” 505 exits the panel without making any selection. At the bottom there are settings to list only connected instruments 506 as well as to use a matching filter criterion 507, in case the previous option is selected. An enable filtering check box 507 is also implemented to allow enabling/disabling the filtering operation without changing the matching pattern. If the “List only connected devices” 506 check box is not checked, the dialog simply lists all possible legal address, without additional information. If the “List only connected devices” 506 is checked, the address of the currently connected instruments are listed. The list may be accompanied with the corresponding instrument ID based on the implementation and check box 508. When the “List only connected devices” box 506 is checked, then the “Filter” check box 507 becomes enabled. If the user check the “Filter” check box 507 without entering any text in the corresponding text box, the instrument ID is shown in the list box for the connected instruments. If additionally there is a pattern in the edit box, that pattern is used to filter the listed instruments and show only those matching the search pattern.

Typically, the user provides/enters/types in the instrument address on the bus (see for example FIG. 3) before connecting a piece of software to the instrument. This could be a fixed value programmed in the code or could be a software selection box/dialog. This process of user input may be replaced by a GUI interface that allows the user to list only the instruments presently connected to the computer, as well as filter the list based on pattern matching criteria (see for example FIG. 4 and FIG. 5). Referring to FIG. 6 an exemplary method includes opening a connection to the underlying bus controller/resource manager on the computer at block 601, for example by calling viOpenDefaultRM( . . . ). At block 602, the list of connected instruments is queried from the resource manager by initially calling viFindRsrc( . . . ) and then stepping through the resources with viFindNext( . . . ). At block 603, for each instrument address returned, open a connection to the instrument with viOpen( . . . ) (block 604), query the instrument identification string with the standard SCPI command “*IDN?” (block 605), close the connection to the instrument with viClose( . . . ) (block 606). At block 607, each returned ID is compared with a pattern entered by the user, such as “Keithley 2400” (different techniques for pattern matching could be used, such as regex). A complete list of the instruments (block 608) is filtered based on the pattern matching and presented to the user through the GUI at block 609. The user selected instrument address is returned to the control software to be use for its subsequent connections to the instrument.

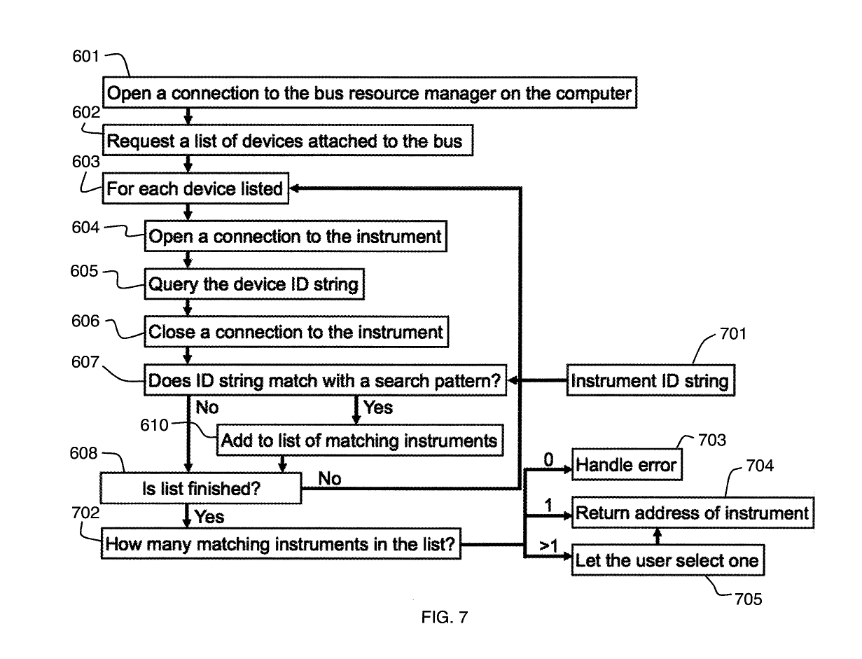

Exemplary methods underlying the GUIs presented in FIG. 6 and FIG. 7 and allow filling in the content of the list/combo box based on the matching criteria entered by the user in the dialog box. These procedures are enabled when the “List only connected devices” is checked. Methods of block 303 and 304 are enabled when there is a matching pattern entered by the user, otherwise only the list of connected instruments is created.

In many experiments, only one instrument of a given type is connected/available on the bus. In another embodiment of the present disclosure, the user provides just the matching pattern of a known instrument instead of the exact instrument address. This could be achieved with a panel or text entry box where the user would specify the matching pattern and then trigger a search of such instrument. This allows instruments to be shared/replaced with different addresses, etc. The software would implements the method of blocks 601-608 and 610, described with reference to FIG. 6. Further, the user input would include an “Instrument ID string” 701. Once the list of connected instruments is created and filtered based on the user criterion at block 608, a number of matches are determined at block 702. Where the list is empty or an error occurred through the previous steps 703 the user is informed and the procedure is terminated, a retry is performed, or the matching criteria is changed, e.g., using a GUI such as FIG. 4 or FIG. 5 to further help the user selection. At block 704, the list contains only one entry; the instrument address of the unique entry will be automatically selected and returned to the control software for its subsequent connections to the instrument, without additional user intervention. At block 705, the list contains multiple entries; the GUI provides the information to the user to allow for its final selection/decision as in the previous embodiment.

Different control applications may be developed for controlling specific types of instrument. According to another embodiment of the present disclosure, the matching pattern may be embedded in the code of the control software or in a setting file, without requiring the user to provide for it at run time.

It is to be understood that embodiments of the present disclosure may be implemented in various forms of hardware, software, firmware, special purpose processors, or a combination thereof. In one embodiment, a software application program is tangibly embodied on a program storage device. The application program may be uploaded to, and executed by, a machine comprising any suitable architecture.

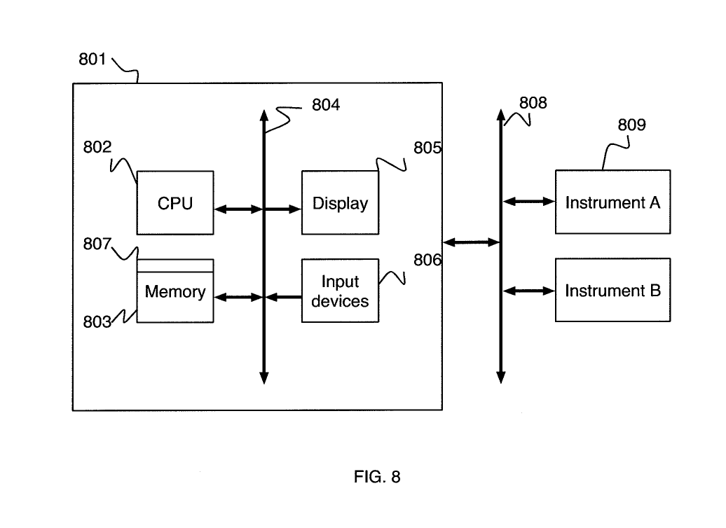

Referring now to FIG. 8, according to an embodiment of the present disclosure, a computer system 801 for automatic instrument address recognition can comprise, inter alia, a central processing unit (CPU) 802, a memory 803 and an input/output (I/O) interface 804. The computer system 801 is generally coupled through the I/O interface 804 to a display 805 and various input devices 806 such as a mouse and keyboard. The support circuits can include circuits such as cache, power supplies, clock circuits, and a communications bus. The memory 803 can include random access memory (RAM), read only memory (ROM), disk drive, tape drive, etc., or a combination thereof. The present invention can be implemented as a routine 807 that is stored in memory 803 and executed by the CPU 802 to process a signal from instruments 809 attached to a data communications bus 808. As such, the computer system 801 is a general purpose computer system that becomes a specific purpose computer system when executing the routine 807 of the present disclosure.

The computer platform 801 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the system is programmed. Given the teachings of the present disclosure provided herein, one of ordinary skill in the related art will be able to contemplate these and similar implementations or configurations of the present disclosure.

Having described embodiments for a system and method of automatic instrument address recognition, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer readable medium embodying instructions executable by a processor to perform method for automatic instrument address recognition, the method comprising:
requesting a list of instruments attached to a bus;
collecting the list of instruments;
querying each listed instrument for an identification string;
comparing the identification string of each instrument to a matching pattern, and determining a match of the identification string with an instrument of interest; and
selecting an address of the instrument having the identification string matching the matching pattern and returning the address for controlling the instrument of interest.

2. The computer readable medium of claim 1, wherein querying each listed instrument further comprises opening a connection to an instrument prior to the querying and closing the connection to the instrument upon receiving a respective identification string.

3. The computer readable medium of claim 1, further comprising:
determining more than one instrument of interest which has a respective identification string matching the matching pattern;
adding, for each match, an indication of the instrument of interest to a list displayed in a graphical user interface; and
displaying the list, wherein the indications in the list are selectable for selecting the corresponding address of the instrument of interest.

4. The computer readable medium of claim 1, wherein the matching pattern is a portion of the identification string.

5. The computer readable medium of claim 1, further comprising limiting the querying of each listed instrument to connected instruments.

6. The computer readable medium of claim 1, wherein the matching pattern is not an instrument address on the network.

7. A network management system comprising:
a data communications bus;
a plurality of instruments connected to the data communications bus; and
a computer system connected to the data communications bus for controlling at least one of the instruments, the computer system comprising a processor and a memory storing instructions executable by the processor to perform a method for automatic instrument address recognition comprising:
requesting a list of the instruments attached to the data communications bus;
collecting the list of instruments;
querying each listed instrument for an identification string;
comparing the identification string of each instrument to a matching pattern, and determining a match of the identification string with an instrument of interest; and
selecting an address of the instrument matching the matching pattern and returning the address for controlling the instrument of interest.

8. The network management system of claim 7, wherein querying each listed instrument further comprises opening a connection over the data communications bus to an instrument prior to the querying and closing the connection to the instrument upon receiving a respective identification string.

9. The network management system of claim 7, wherein the method further comprises:
determining more than one instrument of interest which has a respective identification string matching the matching pattern;
adding, for each match, an indication of the instrument of interest to a list displayed in a graphical user interface; and
displaying the list, wherein the indications in the list are selectable for selecting the corresponding address of the instrument of interest.

10. The network management system of claim 7, wherein the matching pattern is a portion of the identification string.

11. The network management system of claim 7, wherein the method further comprises limiting the querying of each listed instrument to connected instruments.

12. A computer readable medium embodying instructions executable by a processor to perform a method for automatic instrument address recognition, the method comprising:
requesting a list of instruments attached to a bus;
collecting the list of instruments;
querying each listed instrument for a respective identification string;
comparing the respective identification string of each instrument to a matching pattern, and determining a match corresponding to at least one instrument of interest;
selecting an address of the at least one instrument of interest having the respective identification string matching the matching pattern and returning selected addressed for controlling the at least one instrument of interest; and
sending a command to a respective address of the at least one instrument of interest for performing a task.

13. The computer readable medium of claim 12, wherein querying each listed instrument further comprises opening a connection to an instrument prior to the querying and closing the connection to the instrument upon receiving a respective identification string.

14. The computer readable medium of claim 12, further comprising:
determining more than one instrument of interest which has a respective identification string matching the matching pattern;
adding, for each match, an indication of the instrument of interest to a list displayed in a graphical user interface; and
displaying the list, wherein the indications in the list are selectable for selecting the corresponding address of the instrument of interest.

15. The computer readable medium of claim 12, wherein the matching pattern is a portion of the identification string.

16. The computer readable medium of claim 12, further comprising limiting the querying of each listed instrument to instruments connected to the data communications bus.

17. The computer readable medium of claim 12, wherein the matching pattern is not an instrument address on the network.

18. A method of creating a networked device comprising:
providing a network, wherein the network comprises an instrument, a bus, and a controller;
requesting, by the controller, a list of instruments attached to a bus including the instrument;
collecting the list of instruments;
querying each listed instrument for an identification string;
comparing the identification string of the instrument to a matching pattern, and determining a match of the identification string with the instrument;
selecting an address of the instrument having the identification string matching the matching pattern and returning the address for controlling the instrument of interest; and
opening a connection between the controller and the instrument via the bus to create the networked device comprising the instrument, the bus, and the controller, wherein the instrument receives a query from the controller via the bus and performs a process in response to the query.

19. The method of claim 18, wherein querying each listed instrument further comprises opening a connection to the instrument prior to the querying and closing the connection to the instrument upon receiving a respective identification string.

20. The method of claim 18, further comprising:
determining more than one instrument of interest, including the instrument, which has a respective identification string matching the matching pattern;
adding, for each match, an indication of the instrument of interest to a list displayed in a graphical user interface; and
displaying the list, wherein the indications in the list are selectable for selecting the corresponding address of the instrument of interest.

21. The method of claim 18, wherein the matching pattern is a portion of the identification string.

22. The method of claim 18, further comprising storing the matching pattern at the controller.

23. The method of claim 18, wherein the matching pattern is not an instrument address on the network.
